(19) United States
(12) Patent Application Publication
(10) Pub. No.: US 2006/0212174 A1
(43) Pub. Date: Sep. 21, 2006

(54) Method for easy configuration of options within a dynamic HVAC control network using an advanced communicating front-end device

(75) Inventors: Richard W. Garmon, Harwinton, CT (US); Arthur A. Provost, Windsor, CT (US); Laurie R. Robbins, Windsor, CT (US)

Correspondence Address: WALL MARJAMA & BILINSKI, 101 SOUTH SALINA STREET, SUITE 400, SYRACUSE, NY, 13202, US

(73) Assignee: Carrier Corporation, Farmington, CT (US)

(21) Appl. No.: 11/083,515

(22) Filed: Mar. 18, 2005

(51) Int. Cl. G05D 23/00

(52) U.S. Cl. 700/276

(57) ABSTRACT

A method to selectively present a list of parameter options on a front end device can be used to configure a target device. It comprises the steps of, selecting a target device to be configured, displaying a list of configurable parameters, selecting a parameter to configure, querying the target device for a set of valid parameter options, returning a set of valid parameter options from the target device to the front end device based on the current state of the target device, and displaying the list of valid parameter options on the front end device. An HVAC system capable of performing the method, selectively presents a list of parameter options used to configure an HVAC system component. The front end device presents a list of valid parameter options to a user based on the current state of the target device.

### FIELD OF THE INVENTION

This invention relates generally to the configuration of HVAC computer control boards and more particularly to a system and method to poll system components to configure computer control boards based on the current state of each HVAC component.

### BACKGROUND OF THE INVENTION

Heating, ventilation, and air conditioning (“HVAC”) systems typically use one or more computer control boards to control a variety of HVAC systems. Embedded software running on the computer boards controls the HVAC systems to accomplish the desired HVAC functions such as controlling the temperature and humidity of various spaces in a building. The embedded software must be configured for each unique HVAC installation. Configuration information includes limits and parameters for HVAC system components as well as various parameters and limits used by the control algorithms running on the microprocessor on the computer control board.

In current practice, an installation technician configures each computer control board (referred to herein as the “target device”) by entering values (“parameters”) corresponding to the equipment that they have connected to the board. The parameters are typically entered using computer or terminal device referred to herein as the “front end device”. The embedded software uses these parameters in the control program running on the target device. Configuration parameters might never be changed during the life of the system. Or, a technician or user might later change one or more configuration parameters to modify the performance of the system or to add or replace an HVAC component.

The problem is that the list of configuration parameter options used at installation can become invalid or non-optimum as HVAC system components fail in part or in whole, or as the performance of one or more components changes with time, or ambient environmental conditions change, such as when a system goes over largely to cooling and dehumidifying following a winter heating season. For example, parts of HVAC system components or entire system components may be offline for failure or servicing. Or, the performance of some components may have changed over time, such as by reduced air flow in an air handler caused by a dirty filter or with ambient environmental conditions. After such changes, the list of valid configuration parameters for each HVAC system component is likely to be different from the original list used by the installation technician. Therefore, what is needed is an HVAC computer control board that can return a valid list of parameter configuration options based on the current state of the HVAC component and its related sensors.

### SUMMARY OF THE INVENTION

A method to selectively present a list of parameter options on a front end device can be used to configure a target device. It comprises the steps of, selecting a target device to be configured, displaying a list of configurable parameters, selecting a parameter to configure, querying the target device for a set of valid parameter options, returning a set of valid parameter options from the target device to the front end device based on the current state of the target device, and displaying the list of valid parameter options on the front end device.

An HVAC system capable of performing the method, selectively presents a list of parameter options used to configure an HVAC system component. The system comprises a front device coupled to a communication link, the front end device to configure a parameter and a target device coupled to a communication link. The target device can control an HVAC system component. The target device has at least one input to receive information related the control of the HVAC component, and at least one output to control the HVAC component. The front end device presents a list of valid parameter options to a user based on the current state of the target device when the user selects a specific parameter to configure the HVAC system component.

### BRIEF DESCRIPTION OF THE DRAWINGS

For a further understanding of these and other objects of the invention, reference will be made to the following detailed description of the invention which is to be read in connection with the accompanying drawing, where:

FIG. 1 shows a block diagram of a system to carry out the inventive method;

FIG. 2 is a block diagram showing the inventive method steps; and

FIG. 3 shows a block diagram representation of an embodiment of the system controlling an air handler.

It is to be understood that the drawings are for the purpose of illustrating the concepts of the invention and are not necessarily drawn to scale.

### DETAILED DESCRIPTION OF THE INVENTION

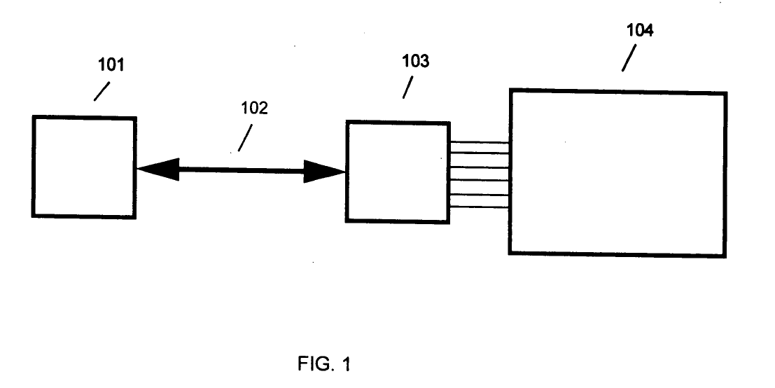

The inventive system and method to configure an HVAC system component computer control board (the “target device”) can be described in terms of the system shown in FIG. 1. Front end device 101 is connected by digital communication link 102 to a target device 103. Communication link 102 can be any type of digital link, for example a serial digital link, and can support one or multiple target devices 103 on one link. For simplicity, only one target device 103 is shown in FIG. 1. Front end device 101 can be a digital device used to communicate with target device 103 via digital communication link 102. Front end device 101 can be a general purpose computer running software suitable to communicate with target device 103, or it can be a special purpose microprocessor based terminal having embedded software to communicate with target device 103. Target device 103 can be a microprocessor based controller that controls HVAC system component 104. Target device 103 can also read values representing various sensor measurements, positions, or one or more status indications related to HVAC system component 104. Target device 103 can also control parts of HVAC system component 104, such as by setting the position of a damper or controlling a fan motor.

One or more parameters are associated with target device 103. The parameters relate to the corresponding HVAC system component 104 controlled by target device 103. The term parameter as used with respect to the inventive method can relate to one or more set point temperatures, humidity settings, operating modes of equipment, or physical parameters, such as the position of a damper. A parameter can also specify a group of set points in the form of a set point schedule. A set point schedule is a logical grouping of set point information. Or, a parameter can simply be used to select a choice from a list of options. For example, a configuration parameter can be specified to choose a particular available HVAC control algorithm from a list of available algorithms.

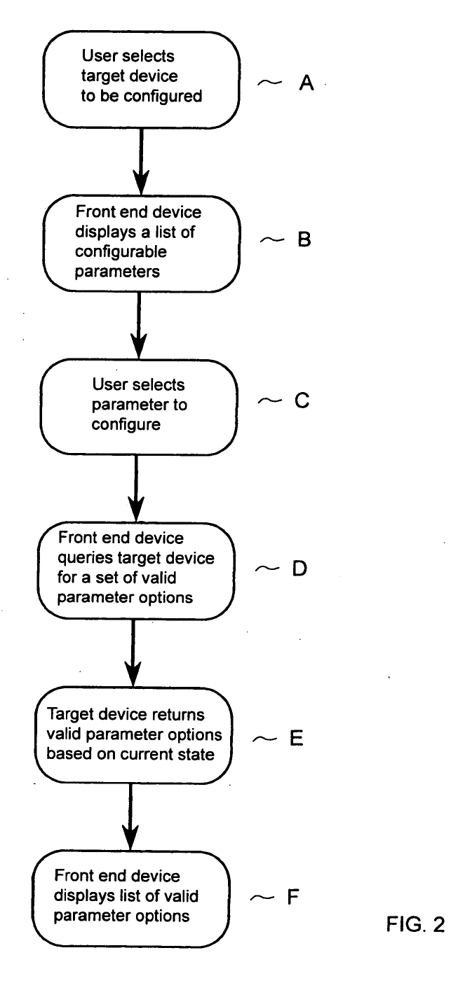

Turning to FIG. 2, the configuration method is now described in terms of the system shown in FIG. 1. In block A, a user of front device 101 selects a target device 103 to be configured. In block B, front end device 101 displays a list of configurable parameters for the selected target device 103. In block C, the user selects a parameter to configure. Following the user selection, in block D, front end device 101 queries the selected target device 103 via communication link 102 for a set of valid options for the specific parameter. In block E, target device 103 examines its current state reflecting the state of all controlled components and sensors, creates a list of valid options for the specific parameter, and returns a list of valid options for the specific parameter to front end device 101. In block F, front end device 101 displays the returned list and allows the user to select one valid option that is then sent to target device 103.

The inventive method can be used to configure various types of HVAC system components in relation to three types of conditions: prior user configuration, abnormal condition, and operating mode. Using the inventive method, these conditions can be considered at the time of a parameter selection to determine a valid list of options for a specific parameter.

The first condition is prior user configuration. A target device 103 can be adapted to several different types of HVAC system components 104, including air handlers, chillers, etc., or other types of equipment such as lighting controls. At commissioning, an installer typically selects a specific application for target device 103 to run, for example to support an air handler as an HVAC system component 104. The installer then identifies and sets a baseline set of runtime characteristics for operation of the HVAC system component 104 by setting an initial selection of parameters. At some later time, a user may wish to enhance the behavior of target device 103 by changing a configuration parameter, for example by enabling a new control algorithm. Under the inventive method, a user can access an air handler computer control board, an exemplary target device 103, using front end device 101 via digital communication link 102. Following a query regarding parameters related to control algorithms, target device 103 returns only a list of algorithms that apply to the baseline configuration. A list of relevant algorithms for an air handler, as an exemplary HVAC system component 104, could include specific algorithms such as night time free cooling, indoor air quality (“IAQ”), etc.

The second condition that can be considered during parameter selection is an abnormal condition. User configuration options can be affected by abnormal conditions such as failed temperature sensor. Consider for example a system where several temperature sensors are connected to a target device 103 associated with the control of an air handler. Two or more of the sensors can be configured as a sensor set where the temperatures measured by the individual sensors are averaged. A user might desire to reconfigure the group of sensors in the sensor set. In this exemplary system using the inventive method, a user would use front end device 101 to select the air handler and then the parameter representing the sensor set. Before presenting the user with a list of options for configuring the sensor set parameter, front end device 101 would query target device 103 for the current status of all sensors that might be suitable for a list of sensor set options. An exemplary sensor set might comprise various combinations of three temperature sensors. Normally, target device 103 would return the various permutations of the temperature sensors as options for valid averaging configurations. But, if target device 103 determines that one of the sensors is malfunctioning following the query, it will only return a list of current valid parameter options. According to the inventive method, the list returned by target device 103 would not offer the user any parameter options including the bad sensor.

The third condition that can be considered by the inventive method is operating mode. Many HVAC system components automatically take on certain operating modes depending on environmental conditions. Such conditions include temperature, humidity, daytime/night time modes, or whether an environmentally controlled space is occupied or not. In a system performing the inventive method, when a user selects a target device 103 and a specific parameter to be set, the list of options for that parameter is a subset of all options that are valid for the current mode of the associated HVAC system component 104. When the user selects the specific parameter, front end device 101 queries target device 103 regarding its current operating mode and parameter options that are available for target device 103 for that mode. Front end device 103 then displays only the parameter options that are currently available and relevant to the current operating mode. Thus, parameter options that are not relevant to the current operating mode are not displayed.

The three following examples that follow illustrate a system carrying out the inventive method. In each example, a list of options for a parameter list is created and returned by target device 103 for use in an air handler damper control algorithm. Example 1 was set up in a lab to show parameter selection influenced by a baseline (prior user) configuration. Example 2 contemplates parameter selection influenced by an abnormal condition, a failed temperature sensor. And, Example 3 contemplates a parameter selection influenced by an operating mode, the personnel occupied or non-occupied status of building spaces having temperature sensors that can serve as inputs to a damper control algorithm.

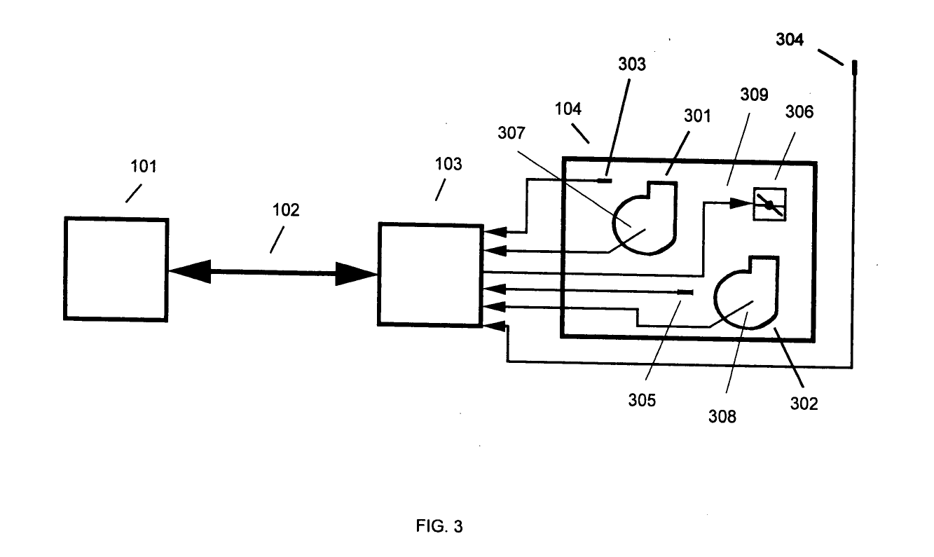

For example 1, an exemplary system was setup for testing the inventive method as shown in the block diagram of FIG. 3. Front end device 101 was a Carrier Corporation “System Pilot” with a display and knobs and buttons for a user interface. A Carrier Corporation proprietary RS-485 serial protocol link (the Carrier Corporation communicating network) was used as communication link 102. While a proprietary protocol was used in this test, it should be emphasized that the invention can be practiced using any suitable communication link, including various types of serial links that are well known to those skilled in the art. Target device 103 was a Carrier Corporation “universal controller”. The universal controller, shown in FIG. 3 as target device 103, has a total of 16 available input and output (“I/O”) channels. Eight of the universal controller channels can be configured as various types of input channels (digital or analog) and eight other channels can be configured as digital or analog output channels. The universal controller is typical of a field installable target device 103 that can control an HVAC system component 104. For the test, each I/O channel was assigned a unique name for identification and a specific set of attributes that determined how the data for that channel was to be interpreted. Exemplary attributes included a temperature sensor, a relative humidity sensor, and a discrete latched digital input. Only those inputs and outputs used in the test are shown in FIG. 3.

Example 1: Continuing with the block diagram representation of the simulated HVAC system shown in FIG. 3, a baseline configuration included two temperature sensors 303 and 304, labeled SPT and SAT, as analog inputs to target device 103, one relative humidity sensor 305, named RH, two discrete digital inputs indicating the on/off state of the two fans labeled as PRIMARY FAN and SECONDARY FAN as 307 and 308, and one analog output 309 controlling the position of damper 306 in the air handler. To demonstrate a prior user configuration application, all I/O was defined and named as a complete baseline configuration. HVAC system component 104 was specified as an air handler having two fans 301 and 302. Front end device 101, the system pilot, was used to configure a parameter that affects a particular algorithm's (algorithm A) run time behavior. The parameter chosen for the test related to the selection of which fan on/off indication would use be used by the damper algorithm. The system pilot was then used to configure an algorithm to control damper 306. One configurable parameter was the name of the sensor to indicate the operating status of a fan. The user selected the target device and the fan status parameter for the damper algorithm. The system pilot then queried the universal controller for a list of sensors that would be acceptable for this source of information. The universal controller replied with the list of PRIMARY FAN 307 and SECONDARY FAN 308. The user then selected PRIMARY FAN 307 as this parameter.

Example 2: It is further contemplated that the exemplary system of FIG. 3 can determine if a component or sensor related to the selection of a specific parameter is defective or otherwise inoperative. For example, consider the case where the user can choose a parameter from a list of temperature sensor inputs. The parameter will serve as an input parameter for use in a damper algorithm where the damper is part of an air handler. In this example, the universal controller 103 has previously determined that sensor 303 SPT is inoperative. Such a determination can be made using techniques well known to those skilled in the art such as detecting an open or shorted sensor circuit or an out of range value. The user selects target device 103 controlling the air handler 104 and the temperature parameter with the system pilot. Before presenting the list of options, the system pilot queries the universal controller 103 for a valid list of temperature sensors suitable for the parameter being selected. The universal controller determines that sensor 303 SPT is inoperative and therefore returns only one option, temperature sensor 304 SAT, even though the installation has two temperature sensors 303 and 304 originally installed.

Example 3: In this example, it is contemplated that the parameter list created and returned by the universal controller target device 103 can reflect a current operational configuration. This example once again refers to the system as shown in FIG. 3. Here, the user can choose a parameter that inputs a temperature as reflected by one of the two sensors (303 or 304) or the average of the two sensors, to the damper algorithm. Another input to the universal controller (not shown) indicates whether or not the building environmental spaces monitored by temperature sensors 303 and 304 are occupied by persons. Such a determination can be made using techniques well known to those skilled in the art such as infrared (IR) sensors or by one or more switches as set by a building manager or other user. In this example, the room where the temperature is monitored by temperature sensor 304 SAT is unoccupied. The user selects target device 103 controlling air handler 104 and the temperature parameter on the system pilot serving as front end device 101. Before presenting the list of options, the system pilot queries universal controller 103 for a valid list of temperature sensors suitable for the parameter being selected. The universal controller, on determining that the room monitored by sensor 304 SAT is unoccupied, returns only one option, temperature sensor 303 SPT, even though the installation has two temperature sensors (303 and 304) originally installed. In view of the unoccupied status of the room monitored by sensor 304, the less suitable parameter options of sensor 304 or the average of sensors 303 and 304 are not displayed as valid options.

It can now be seen that the inventive system and method presents a user of a front end device with only a list of the valid configuration options for that parameter based on the current state of the target device. The current state of the target device can be determined by baseline configuration, operating mode, and/or abnormal conditions. The list of options for a parameter to be selected can be tailored at the moment the user selects the parameter for configuration such that it reflects the most current baseline configuration, any abnormal conditions, and the current operating mode of the HVAC system component controlled by the target device.

It should further be emphasized that the front end device can be any general purpose computer running a program suitable for communicating with a target device. Such computers include personal computers, laptop and notebook computers, wearable computers, and hand held computers. Similarly the target device can be any suitable microprocessor based controller board having a communications port, such as a serial link, and inputs and outputs to interact with an HVAC system component.

While the present invention has been particularly shown and described with reference to the preferred mode as illustrated in the drawings, it will be understood by one skilled in the art that various changes in detail may be effected therein without departing from the spirit and scope of the invention as defined by the claims.

We claim:

1. A method to selectively present a list of parameter options on a front end device used for configuring a target device comprising the steps of:
selecting a target device to be configured;
displaying a list of configurable parameters;
selecting a parameter to configure;
querying the target device for a set of valid parameter options;
returning a set of valid parameter options from the target device to the front end device based on the current state of the target device; and
displaying the list of valid parameter options on the front end device.

2. The method of claim 1 wherein selecting the target device to be configured comprises selecting a controller for an HVAC system component.

3. The method of claim 1 wherein returning a set of valid parameter options from the target device to the front end device based on the current state of the target device comprises returning a set of valid parameter options based on a baseline configuration of an HVAC system.

4. The method of claim 1 wherein returning a set of valid parameter options from the target device to the front end device based on the current state of the target device comprises returning a set of valid parameter options based on an operational mode of an HVAC system component.

5. The method of claim 1 wherein returning a set of valid parameter options from the target device to the front end device based on the current state of the target device comprises returning a set of valid parameter options based on an abnormal condition in an HVAC system component.

6. The method of claim 1 wherein selecting a target device to be configured comprises selecting a target device to be configured using a computer as the front end device.

7. The method of claim 1 wherein selecting a target device to be configured comprises selecting a target device to be configured using a system pilot as the front end device.

8. The method of claim 1 wherein selecting a target device to be configured comprises selecting a universal controller target device to be configured.

9. An HVAC system to selectively present a list of parameter options used to configure an HVAC system component comprising:
a front end device coupled to a communication link, the front end device to configure a parameter;
a target device coupled to a communication link, the target device to control an HVAC system component, the target device having at least one input to receive information related the control of the HVAC component, and at least one output to control the HVAC component;
wherein the front end device presents a list of valid parameter options to a user based on the current state of the target device when the user selects a specific parameter to configure the HVAC system component.

10. The HVAC system of claim 9 wherein the HVAC system component is chosen from the group consisting of furnace, air conditioner, air handler, damper, humidifier, chiller, compressor, and fan.

11. The HVAC system of claim 9 wherein the front end device is selected from the group of front end devices consisting of personal computer, laptop computer, notebook computer, wearable computer, and handheld computer.

12. The HVAC system of claim 9 wherein the front end device is a system pilot.

13. The HVAC system of claim 9 wherein the communication link is a serial digital communication link.

14. The HVAC system of claim 9 wherein the communication link is an RS-485 serial communication link.

15. The HVAC system of claim 9 wherein the communication link is the Carrier Corporation communicating network.

16. The HVAC system of claim 9 wherein the target device is an HVAC system microprocessor based controller.

17. The HVAC system of claim 9 wherein the target device is a Carrier Corporation universal controller.

18. The HVAC system of claim 9 wherein the current state of the target device comprises a state selected from the group consisting of baseline configuration, operating mode, and abnormal condition.

19. The HVAC system of claim 18 wherein the operating mode is determined by a factor selected from the group consisting of temperature, humidity, time of day, season, and personnel occupancy.

20. The HVAC system of claim 18 wherein the abnormal condition is determined by a factor selected from the group consisting of failed temperature sensor, failed humidity sensor, clogged filter, failed fan motor, failed fan status indicator, and failed compressor.
